(19) United States
(12) Patent Application Publication
(10) Pub. No.: US 2025/0354642 A1
(43) Pub. Date: Nov. 20, 2025

(54) CONNECTING PIPE

(71) Applicant: PPI PIPE CO., LTD., Hwaseong-si, Gyeonggi-do (KR)

(72) Inventors: Jong-Ho LEE, Seongnam-si (KR); Hye-Jung LEE, Seongnam-si (KR); Hye-sun LEE, Seongnam-si (KR); ll-Haeng LEE, Suwon-si (KR)

(73) Assignee: PPI PIPE CO., LTD., Hwaseong-si, Gyeonggi-do (KR)

(21) Appl. No.: 18/843,451

(22) PCT Filed: Mar. 3, 2023
(86) PCT No.: PCT/KR2023/002989

§ 371 Date: Mar. 21, 2025

(30) Foreign Application Priority Data
Mar. 4, 2022 (KR) 10-2022-0027890

(51) Int. Cl. F16L 43/02; F16L 58/18

(52) U.S. Cl. CPC F16L 43/02; F16L 58/185

(57) ABSTRACT

The present specification relates to a connecting pipe connected to pipes. In one embodiment, the connecting pipe may comprise: a first opening; a second opening; and a support groove which is vertical to the transverse cross section of the first opening, and which is disposed on a first center line passing through the center of the transverse cross section of the first opening. When the connecting pipe according to embodiments is connected to the pipes, the possibility of breakage or deformation, which can occur at a connecting portion of the connecting pipe and the pipe, can be minimized.

### FIELD

The present disclosure relates to a connecting pipe connected to a pipe.

### DESCRIPTION OF RELATED ART

Fluid such as service water may reach a destination thereof via a pipe for transporting the same. The pipe that transports a great amount of the fluid may be buried underground. A plurality of pipes may be individually buried, and may be connected to each other via connecting pipes.

FIG. 1 is a diagram for illustrating a method for connecting pipes to each other.

The pipes need to be tightly connected to each other to prevent leakage of the fluid from a connection area therebetween. For the pipes to be tightly connected to each other, a strong pressing force is required during a connection work. As shown in FIG. 1, to connect a first pipe 51 with a second pipe 52, a worker performs a task of connecting the first pipe 51 with the second pipe 52 placed at a burial site.

As shown in FIG. 1, the worker may press one end of the first pipe 51 using a stick 60 to insert the first pipe 51 into an opening of the second pipe 52. The worker fixes one end of the stick 60 on the ground and presses the stick 60 in a direction toward the second pipe 52, thereby causing the first pipe 51 to move toward the second pipe 52. By repeatedly performing such task by the worker, the first pipe 51 may be connected to the second pipe 52.

Each of FIGS. 2 and 3 is a diagram showing a connection process of a first pipe and a second pipe.

As described with reference to FIG. 1, when the worker presses the first pipe 51 with the stick 60, the second pipe 52 may be inserted into the first pipe 51. Depending on an embodiment, the first pipe 51 may be inserted into the second pipe 52.

When the first pipe 51 is pressurized by the stick 60, the worker may apply a force to a point deviating from a center line of the first pipe 51. Accordingly, a direction of application of the force applied to the first pipe 51 may not be parallel to a longitudinal direction of the first pipe 51 and the second pipe 52 or a connection direction of the first pipe 51 and the second pipe 52.

In this case, as shown in FIG. 3, the first pipe 51 and the second pipe 52 may be connected to each other in a state in which center lines of the first pipe 51 and the second pipe 52 are not aligned with each other, but are offset from each other. That is, the first pipe 51 and the second pipe 52 may be connected to each other such that longitudinal directions thereof are not aligned with each other, but are offset from each other.

When the first pipe 51 and the second pipe 52 are connected to each other as such, damage or deformation may occur at a connection area of the first pipe 51 and the second pipe 52. In addition, as the first pipe 51 and the second pipe 52 are not in close contact with each other at the connection area thereof, a gap may be generated and the fluid leakage may occur at such gap.

In one example, in a process of burying and connecting the pipes, a connecting pipe having a shape bent to have a predetermined bending angle may be connected to the pipes. When the worker connects the connecting pipe with the pipes, the stick 60 should be placed at a position to meet a center line of the bent connector and press the connecting pipe to ensure that the connecting pipe and the pipe are accurately connected to each other. However, it is difficult for the worker to find a position of the center line of the connecting pipe with the bent shape at a work site.

Therefore, in the process in which the worker connects the connecting pipe with the pipe using the stick 60 as shown in FIG. 1, damage or deformation occurs at a connection area of the connecting pipe and the pipe as the connecting pipe and the pipe are not accurately connected to each other. Additionally, a gap is generated between the connecting pipe and the pipe and the fluid leakage occurs as the connecting pipe and the pipe are not accurately connected to each other.

### DISCLOSURE

### Technical Purposes

The present disclosure is to provide a connecting pipe that may be accurately and easily connected to a pipe by a worker.

The present disclosure is to provide a connecting pipe that minimizes a possibility of damage or deformation that may occur in a connection area when being connected to a pipe.

The present disclosure is to provide a connecting pipe that minimizes a possibility of fluid leakage because no gap occurs in a connection area when being connected to a pipe.

Purposes according to the present disclosure are not limited to the above-mentioned purposes. Other purposes and advantages of the present disclosure that are not mentioned may be understood based on following descriptions, and may be more clearly understood based on embodiments of the present disclosure. Further, it will be easily understood that the purposes and advantages of the present disclosure may be realized using means shown in the claims and combinations thereof.

### Technical Solutions

According to an embodiment, a connecting pipe includes a support groove defined at a position to meet a first center line extending in a flow direction of fluid from a center of a first opening that defines an opening into which a pipe is inserted. When the connecting pipe is connected to the pipe, a stick used by a worker may be inserted into the support groove. When the worker uses the stick to pressurize the connecting pipe, the stick may be supported by the support groove.

The connecting pipe may further include a support formed to protrude outside the connecting pipe and supporting a pressure of fluid introduced into the connecting pipe, and a portion of the support may be depressed to define the support groove.

The support may include a first cell protruding outside the connecting pipe, wherein the first cell is disposed such that a longitudinal direction thereof intersects a flow direction of fluid, wherein the first cell includes a plurality of first cells, and a second cell protruding outside the connecting pipe, wherein the second cell is disposed such that a longitudinal direction thereof is parallel to the flow direction of the fluid, wherein the second cell is connected to each of the plurality of first cells. The support groove may be defined in the second cell.

The support groove may be defined in the second cell between the first cells disposed to be spaced apart from each other.

The second cell may be formed to protrude outwardly of the plurality of first cells, and the support groove may be defined in a protruding portion of the second cell.

The connecting pipe may include a second opening defined at a position opposite the first opening and defining an opening. The support groove may be defined at an end of the second opening.

The support groove may include a pair of support grooves defined to be spaced apart from each other in a direction perpendicular to the first center line.

The connecting pipe may further include a groove defining portion protruding from the end of the second opening, formed in an arc, and formed as the support groove is depressed.

The connecting pipe may include a support that is formed to protrude outside the connecting pipe and supports a pressure of fluid introduced into the connecting pipe, and a second opening defined at a position opposite to the first opening and defining an opening, and the support groove may be defined in one of the support and the end of the second opening.

When the first center line meets the support, the support groove may be defined in the support, and when the first center line does not meet the support, the support groove may be defined in the end of the second opening.

### Technical Effects

The worker may accurately and easily connect the connecting pipe according to the embodiments to the pipe.

When the connecting pipe according to the embodiments and the pipe are connected to each other, the possibility of damage or deformation that may occur in the connection area of the connecting pipe and the pipe may be minimized.

When the connecting pipe according to the embodiments and the pipe are connected to each other, no gap occurs in the connection area of the connecting pipe and the pipe, so that the possibility of fluid leakage may be minimized.

### BRIEF DESCRIPTION OF DRAWINGS

FIG. 1 is a diagram for illustrating a method for connecting pipes to each other.

Each of FIGS. 2 and 3 is a diagram showing a connection process of a first pipe and a second pipe.

FIG. 4 is a perspective view showing a connecting pipe according to an embodiment.

FIG. 5 is a cross-sectional view showing a connecting pipe and a pipe shown in FIG. 4.

FIG. 6 is a cross-sectional view showing a coupled state of a connecting pipe and a pipe in FIG. 5.

FIG. 7 is a perspective view showing a connecting pipe according to another embodiment.

FIG. 8 is a cross-sectional view of a connecting pipe shown in FIG. 7.

FIG. 9 is a perspective view showing a connecting pipe according to another embodiment.

FIG. 10 is a cross-sectional view of a connecting pipe shown in FIG. 9.

FIG. 11 is a perspective view showing a connecting pipe according to another embodiment.

FIG. 12 is a cross-sectional view of a connecting pipe shown in FIG. 11.

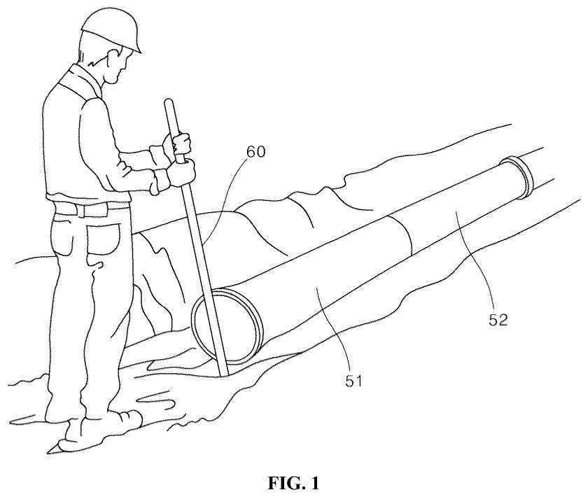

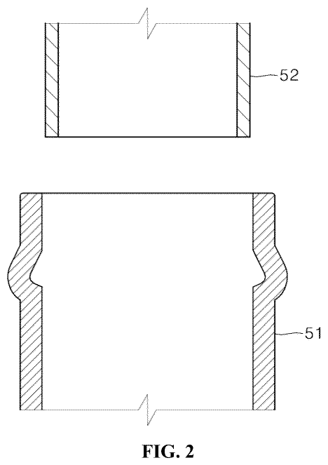

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

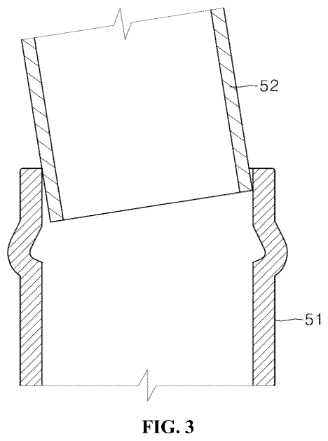

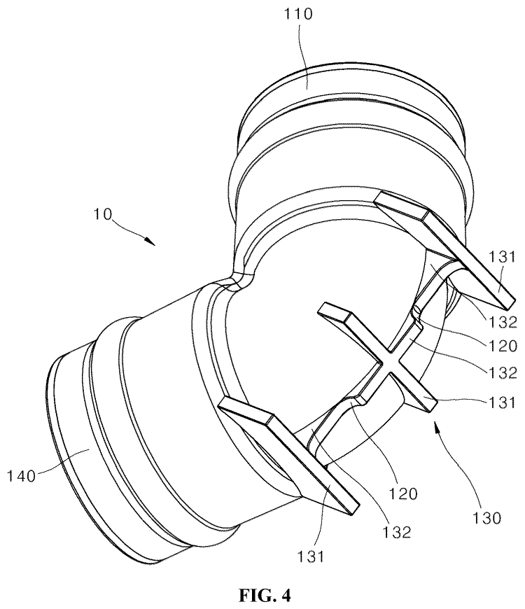

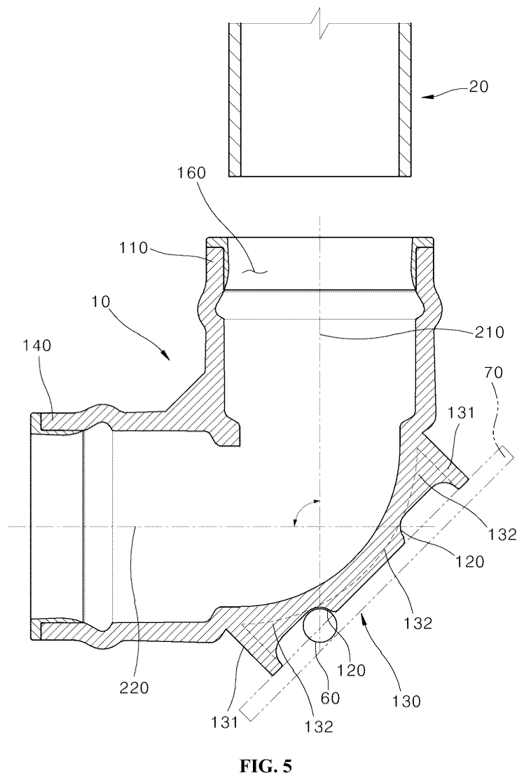

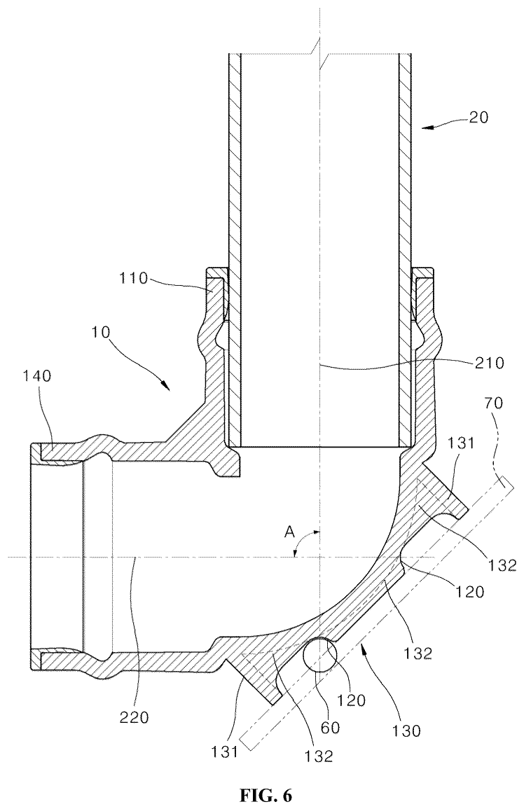

FIG. 4 is a perspective view showing a connecting pipe 10 according to an embodiment. FIG. 5 is a cross-sectional view showing the connecting pipe 10 and a pipe 20 shown in FIG. 4. FIG. 6 is a cross-sectional view showing a coupled state of the connecting pipe 10 and the pipe 20 in FIG. 5.

The connecting pipe 10 according to an embodiment may be connected to the pipe 20 through which fluid flows. Different pipes may be connected to respective ends of the connecting pipe 10. The connecting pipe 10 may have a bent shape to have a predetermined bending angle.

The connecting pipe 10 may include a first opening 110. The first opening 110 may have a circular cross-section, and an opening into which the pipe 20 is inserted may be defined in the first opening 110.

A support groove 120 may be defined in the connecting pipe 10. The support groove 120 may be defined on a first center line 210 extending from a center of the first opening 110 in a flow direction of the fluid. The first center line 210 may also be defined as a straight line that is perpendicular to a cross-section of the first opening 110 and passes through a center of the cross-section of the first opening 110.

The worker may couple or connect the connecting pipe 10 with the pipe 20 by pressing the connecting pipe 10 using the stick 60. For example, the worker may place the connecting pipe 10 and the pipe 20 on the ground such the first opening 110 of the connecting pipe 10 and one end of the pipe 20 face each other. Next, the worker may fix one end of the stick 60 to the ground and then place a body of the stick 60 to be supported in the support groove 120. The worker may push the stick 60 in a direction toward the pipe 20, that is, in a direction in which the connecting pipe 10 is coupled with the pipe 20, while the stick 60 is supported by the support groove 120. Accordingly, while the stick 60 is fixed to the ground, the connecting pipe 10 may be pressurized via the support groove 120, so that the connecting pipe 10 may move in the direction toward the pipe 20. By repeating such process, the pipe 20 may be accurately connected to the first opening 110 of the connecting pipe 10.

A mounting space 160 in which the pipe 20 is mounted may be defined inside the connecting pipe 10. Therefore, when the worker presses the connecting pipe 10 with the stick 60, the end of the pipe 20 may be inserted into the mounting space 160, and continue to slide and move on an inner surface of the mounting space 160. When a distal end of the pipe 20 comes into contact with a step formed at a distal end of the mounting space 160, the coupling of the pipe 20 and the connecting pipe 10 may be completed.

Because the support groove 120 is disposed on the first center line 210, when the worker pushes the stick 60 while the stick 60 is supported by the support groove 120, the stick 60 always pressurizes the connecting pipe 10 on the first center line 210.

Because of such structure, when the stick 60 pressurizes the connecting pipe 10, a direction of application of the pressing force aligns with the longitudinal direction of the pipe 20. Further, a point of application of the pressing force is at the center of the first opening 110 and a center of the pipe 20. Therefore, when the connecting pipe 10 and the pipe 20 are connected to each other using the stick 60, the connecting pipe 10 and the pipe 20 may be connected to each other accurately without being misaligned. Therefore, a possibility of damage or deformation in the connection area of the connecting pipe 10 and the pipe 20 is significantly reduced. Additionally, because no gap is formed in the connection area of the connecting pipe 10 and the pipe 20, a possibility of water leakage occurring in the connection area of the connecting pipe 10 and the pipe 20 is significantly reduced.

The bending angle of the connecting pipe 10 may vary depending on an embodiment. The support groove 120 may be defined at the position to meet the first center line 210, but the position of the support groove 120 may vary depending on the bending angle of the connecting pipe 10.

Accordingly, the bending angle of the connecting pipe 10 will first be described, and then each embodiment of the connecting pipe 10 in which the support groove 120 is defined at a different position in the longitudinal direction of the connecting pipe 10 will be described.

The bending angle may be described as an intersection angle A. The connecting pipe 10 may include a second opening 140 defined at a position opposite to the first opening 110 and defines an opening. In this regard, a second center line 220 extending straight from a center of the second opening 140 in the flow direction of the fluid may be drawn. The second center line 220 may be defined as a straight line that is perpendicular to a cross-section of the second opening 140 and passes through a center of the cross-section of the second opening 140.

The intersection angle A refers to a smaller angle between the first center line 210 and the second center line 220. When an angle between first center line 210 and second center line 220 is 90°, the intersection angle A is 90°.

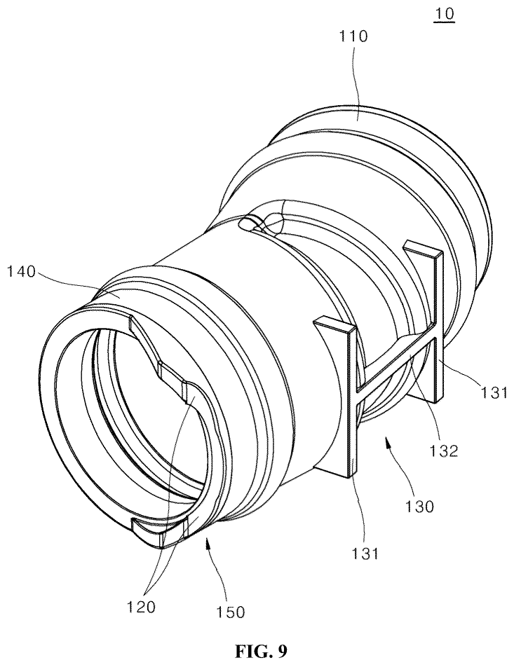

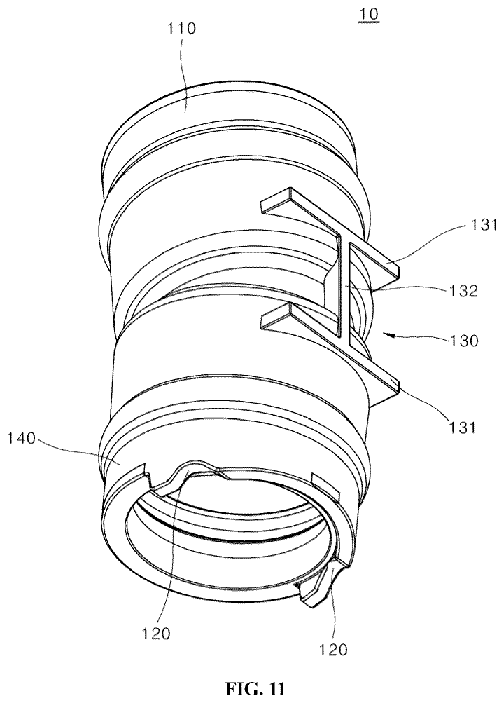

The bending angle of the connecting pipe 10 may vary depending on the intersection angle A. For example, in the embodiment shown in FIG. 4, the intersection angle A is 90°. In an embodiment shown in FIG. 7, the intersection angle A is 45°. In embodiments shown in FIGS. 9 and 11, the intersection angle A is smaller than 45°.

Depending on a magnitude of the intersection angle A, the position of the support groove 120 may vary. For example, the support groove 120 may be defined in a support 130 that is formed to protrude outside the connecting pipe 10 or may be defined at an end of the second opening 140.

Hereinafter, the position of the support groove 120 according to each embodiment will be described in detail with reference to the drawings. First, the embodiment shown in FIGS. 4, 5, and 6 will be described.

The connecting pipe 10 may include the support 130 that is formed to protrude outside the connecting pipe 10 and supports a pressure of the fluid flowing into the connecting pipe 10. Ends of the support 130 may be located on the same plane as a whole. The support 130 may be generally disposed at a center of the connecting pipe 10 in the flow direction of the fluid.

A support plate 70 may be disposed to be in contact with the end of the support 130. When the connecting pipe 10 is buried in the ground, when the support plate 70 is buried so as to be in contact with the support 130 of the connecting pipe 10, a position of the support plate 70 may be fixed by soil.

Therefore, when high-pressure fluid flows inside the connecting pipe 10, a force applied by the fluid is transmitted from the connecting pipe 10 to the support plate 70 and back to the soil, so that the connecting pipe 10 may be stably supported by the support plate 70 and the soil.

Accordingly, vibration or significant shaking of the connecting pipe 10 and the pipe 20 connected thereto resulted from the flow pressure of the fluid may be effectively suppressed.

In the embodiment shown in FIGS. 4 to 6, the connecting pipe 10 has the intersection angle A of 90°. Therefore, the first center line 210 may meet the support 130. In this case, a portion of the support 130 may be depressed to define the support groove 120.

The support 130 may include a first cell 131 and a second cell 132. The first cell 131 may protrude outside the connecting pipe 10, may be disposed such that a longitudinal direction thereof intersects the flow direction of the fluid, and may include a plurality of first cells.

The second cell 132 may protrude outside the connecting pipe 10, may be disposed such that a longitudinal direction thereof is parallel to the flow direction of the fluid, and may be connected to each of the plurality of first cells 131. The first cell 131 and the second cell 132 may be coupled to each other in a grid shape to form the support 130.

The ends of the support 130, where the first cell 131 and the second cell 132 are coupled to each other in the grid shape, may be located on the same plane as a whole, and the support plate 70 may be disposed to be in contact therewith. In this regard, the support groove 120 may be defined in the second cell 132.

In the embodiment shown in FIG. 4, each first cell 131 may be disposed at each end of the second cell 132. That is, the end of the second cell 132 may be disposed to meet the first cell 131. In this case, the support groove 120 may be defined in the second cell 132 at a position between the first cells 131 that are spaced apart from each other.

In this regard, a first cell 131 may further be disposed on each of both sides of the first cell 131 located at the center, so that a total of three first cells 131 may be included. In this regard, the support groove 120 may include a total of two support grooves disposed between the three first cells 131.

Referring to FIG. 5, each of the two support grooves 120 may be disposed at a position where the first center line 210 and the second center line 220 meet each other. Therefore, when the pipe 20 is connected to the first opening 110, the connection work between the pipe 20 and the connecting pipe 10 may be performed by allowing the stick 60 to be supported in the support groove 120 located on the first center line 210.

In one example, when the pipe 20 is connected to the second opening 140, the connection work between the pipe 20 and the connecting pipe 10 may be performed by allowing the stick 60 to be supported in the support groove 120 on the second center line 220.

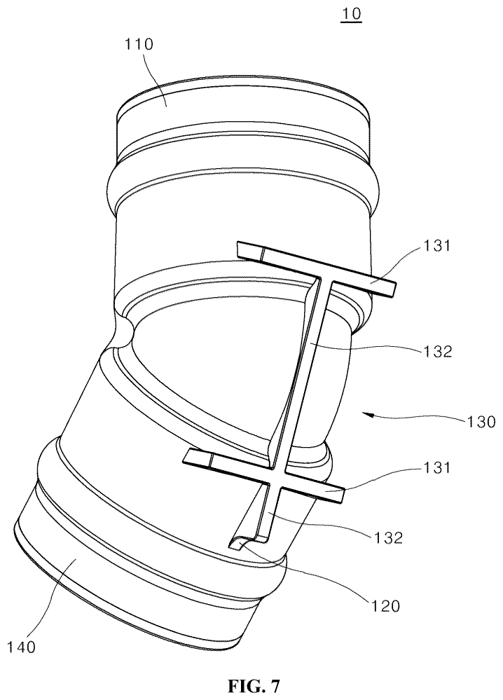

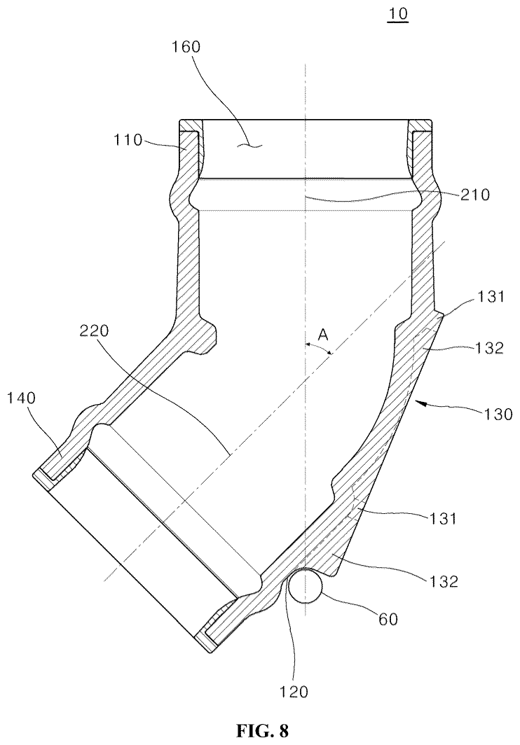

FIG. 7 is a perspective view showing the connecting pipe 10 according to another embodiment. FIG. 8 is a cross-sectional view of the connecting pipe 10 shown in FIG. 7.

The intersection angle A of the connecting pipe 10 shown in FIGS. 7 and 8 is 45°. Even in this case, the first center line 210 may meet the support 130. Therefore, a portion of the support 130 may be depressed to define the support groove 120. In this regard, the second cell 132 may be formed to protrude outwardly of the plurality of first cells 131, and the support groove 120 may be defined at an end of the protruding portion of the second cell 132.

Compared to the connecting pipe 10 shown in FIG. 5, the intersection angle A in FIG. 8 may become smaller, and accordingly, the number of first cells 131 may be reduced to two. However, to expand an area in contact with the support plate 70, a length of the second cell 132 needs to be sufficiently great. Therefore, to secure the sufficient length of the second cell 132, the second cell 132 may be formed to protrude outwardly of the first cell 131.

In this regard, the point where the first center line 210 and the support 130 meet each other is an end of the portion of the second cell 132 that protrudes outwardly of the first cell 131. Accordingly, in the connecting pipe 10 of the shape shown in FIG. 8, the support groove 120 may be defined at the end of the protruding portion of the second cell 132.

In the embodiment shown in FIGS. 9 to 12, the first center line 210 does not meet the support 130. Therefore, the support groove 120 for mounting the stick 60 may be defined in the second opening. Hereinafter, the connecting pipe 10 with such structure will be described in detail.

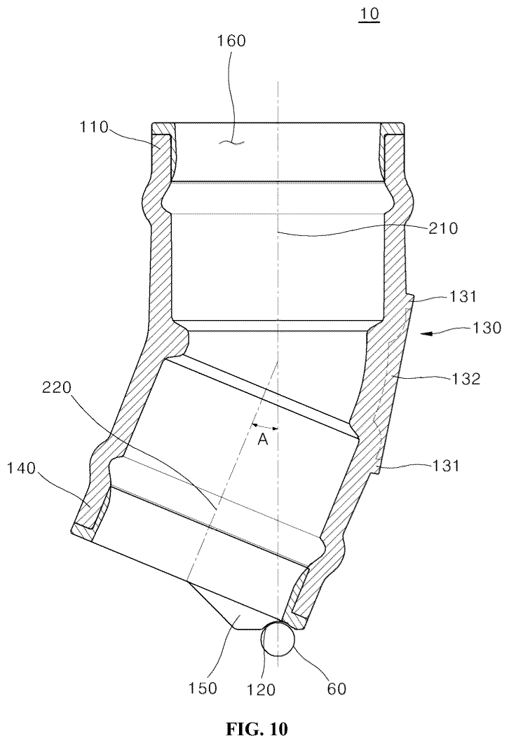

FIG. 9 is a perspective view showing the connecting pipe 10 according to another embodiment. FIG. 10 is a cross-sectional view of the connecting pipe 10 shown in FIG. 9.

The connecting pipe 10 may include the second opening 140 defined at the position opposite to the first opening 110 and defining the opening. Cross-sections of the first opening 110 and the second opening 140 may be circular.

The support groove 120 may be defined at the end of the second opening 140. As the intersection angle A becomes smaller, the support 130 does not meet the first center line 210, and instead, the end of the second opening 140 meets the first center line 210, so that the support groove 120 is defined at the end of the second opening 140.

As shown in FIG. 9 or 11, a pair of support grooves 120 that are spaced apart from each other in a direction perpendicular to the first center line 210 at an end of the second opening 140 may be defined in the second opening 140.

When connecting the connecting pipe 10 with the pipe 20, the worker may allow the stick 60 to be supported in at least one of the pair of support grooves 120 defined to be spaced apart from each other while one end of the stick 60 is fixed to the ground, and then push the stick 60. Accordingly, when the worker pressurizes the connecting pipe 10 using the stick 60, the stick 60 may be prevented from leaving the support groove 120.

The connecting pipe 10 may include a groove defining portion 150 that protrudes from the end of the second opening 140, is formed in an arc, and is formed as the support groove 120 is depressed.

The pipe 20 may be connected to the inside of the second opening 140. In other words, the pipes 20 may be connected to the respective openings at both sides of the connecting pipe 10, so that the connecting pipe 10 may serve as a connection between the pipe 20 and the pipe 20.

Therefore, a length, that is, a length in a direction parallel to the flow direction of the fluid, of the second opening 140 needs to be sufficiently great to prevent the fluid leakage from the connection area after the pipe 20 and the connecting pipe 10 are connected to each other.

Therefore, as the support groove 120 is depressed, the length of the second opening 140 becomes smaller in the support groove 120 and the fluid leakage may occur in the support groove 120, so that it is necessary to ensure that the second opening 140 has the sufficient length.

For this reason, it is appropriate to have the groove defining portion 150 protruding from the end of the second opening 140 and define the support groove 120 to be depressed therein. Accordingly, the groove defining portion 150 may ensure that the second opening 140 has the sufficient length, thereby effectively preventing the fluid from leaking from the second opening 140.

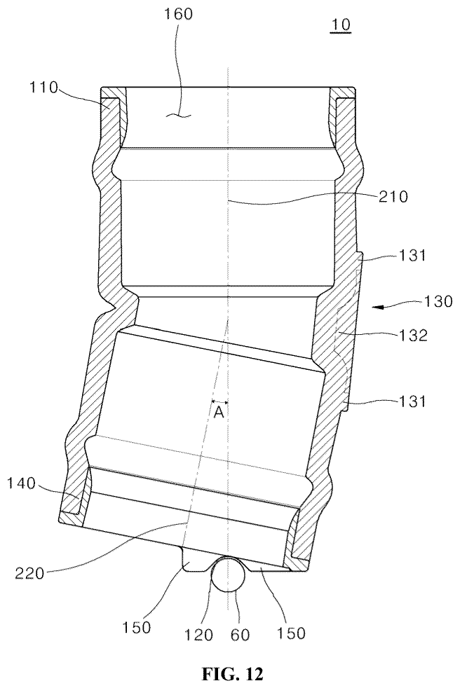

FIG. 11 is a perspective view showing the connecting pipe 10 according to another embodiment. FIG. 12 is a cross-sectional view of the connecting pipe 10 shown in FIG. 11.

Compared to that of the connecting pipe 10 shown in FIG. 9, the intersection angle A of the connecting pipe 10 shown in FIG. 11 is smaller. Also in this case, the first center line 210 and the support 130 do not meet each other, so that the support groove 120 may be defined at the end of the second opening 140. Hereinafter, redundant description of common portions of the connecting pipe 10 shown in FIGS. 9 and 11 will be omitted, and differences between the respective connecting pipes 10 will be described.

The intersection angle A of the connecting pipe 10 shown in FIG. 11 is smaller than that of the connecting pipe 10 in FIG. 9. Accordingly, the support groove 120 may be defined at a position closer to the second center line 220 than that in the connecting pipe 10 in FIG. 9.

When the support groove 120 is defined at the end of the second opening 140, the smaller the intersection angle A, the closer the position of the support groove 120 may be to the second center line 220.

When the intersection angle A is 0°, that is, when the connecting pipe 10 is straight and not bent, the first center line 210 and the second center line 220 may be at the same position, and the support groove 120 may be defined at a position where the first center line 210 and the second center line 220 meet each other.

The characteristics of the connecting pipe 10 according to the embodiments described above are as follows.

The support groove 120 may be defined at the position to meet the first center line 210 extending in the flow direction of the fluid from the center of the first opening 110, which defines the opening into which the pipe 20 is inserted into the connecting pipe 10. The support groove 120 may be defined in one of the support 130 and the end of the second opening.

When the first center line 210 meets the support 130, the support groove 120 may be defined in the support 130. When the first center line 210 does not meet the support 130, the support groove 120 may be defined at the end of the second opening.

In one example, because the intersection angle A may vary depending on the embodiment, there may be cases in which the first center line 210 does not meet any of the support 130 and the end of the second opening in connecting pipe 10. In this case, the portion protruding outwardly of the connecting pipe 10 may be formed at the point where the first center line 210 and the connecting pipe 10 meet each other, and the support groove 120 may be defined in such protruding portion.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is natural that predictable effects of the corresponding configuration should also be recognized.

What is claimed is:

1. A connecting pipe comprising:
a first opening;
a second opening; and
a support groove defined on a first center line perpendicular to a cross-section of the first opening and passing through a center of the cross-section of the first opening.

2. The connecting pipe of claim 1, further comprising a support formed to protrude outside the connecting pipe,
wherein a portion of the support is depressed to define the support groove.

3. The connecting pipe of claim 2, wherein the support includes:
a first cell protruding outside the connecting pipe, wherein the first cell is disposed such that a longitudinal direction thereof intersects a flow direction of fluid, wherein the first cell includes a plurality of first cells; and
a second cell protruding outside the connecting pipe, wherein the second cell is disposed such that a longitudinal direction thereof is parallel to the flow direction of the fluid, wherein the second cell is connected to each of the plurality of first cells,
wherein the support groove is defined in the second cell.

4. The connecting pipe of claim 3, wherein the support groove is defined in the second cell between the first cells disposed to be spaced apart from each other.

5. The connecting pipe of claim 3, wherein the second cell is formed to protrude outwardly of the plurality of first cells,
wherein the support groove is defined in a protruding portion of the second cell.

6. The connecting pipe of claim 1, wherein the support groove is defined at an end of the second opening.

7. The connecting pipe of claim 6, wherein the support groove includes a pair of support grooves defined at the end of the second opening to be spaced apart from each other in a direction perpendicular to the first center line.

8. The connecting pipe of claim 6, further comprising a groove defining portion protruding from the end of the second opening and formed as the support groove is depressed.

9. The connecting pipe of claim 1, further comprising a support formed to protrude outside the connecting pipe,
wherein the support groove is defined in one of the support and the end of the second opening.

10. The connecting pipe of claim 9, wherein when the first center line meets the support, the support groove is defined in the support,
wherein when the first center line does not meet the support, the support groove is defined in the end of the second opening.
